(19) United States
(12) Patent Application Publication
(10) Pub. No.: US 2012/0160983 A1
(43) Pub. Date: Jun. 28, 2012

(54) Rod stiffener

(76) Inventors: Rouslan Gousseinov, Monroe, NY (US); Eldar Guseynov, Fryazino (RU)

(21) Appl. No.: 13/374,234

(22) Filed: Dec. 19, 2011

Related U.S. Application Data
(60) Provisional application No. 61/460,008, filed on Dec. 23, 2010.

(51) Int. Cl. F16M 13/00

(52) U.S. Cl. 248/511

(57) ABSTRACT

A rod stiffener for stabilizing a hanger rod comprising a formed washer, a nut and an elongated stiffener member. The washer has a hole or a cut for the rod and a bended arms or shoulders, embracing said stiffener member from outside and maintaining the rod inside the stiffener member at a fixed position when bolted in place.

### CROSS-REFERENCE TO RELATED APPLICATIONS

The present application claims priority from U.S. application Ser. No. 61/460,008 filed on Dec. 23, 2010, the content of which is hereby incorporated into this application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to a rod stiffener apparatus utilized to stabilize a hanger rod in braced hangers for pipes, ducks and equipments in seismic-wind-dynamic design applications.

The device prevents buckling the rod when it is in compression due to lateral forces on hangers.

From U.S. Pat. No. 6,454,232 a stiffener apparatus for stabilizing a hanger rod having a clamp associated with an elongated stiffener member and shaped plate. The hanger rod is positioned between said plate and said stiffener member and tightened with said clamp.

From “B-Line Systems” hanger rod stiffener is the SC228hanger rod stiffener assembly and strut channel in which a clamp is disposed inside the strut channel to capture the all threaded hanger rod and stiffen it

From “MSS SP-127-2001” a rod is disposed at one side of a strut channel and tightened to said channel with U-bolt and flat two-hole plate.

Prior art hanger rod stiffeners have certain inherent limitations. The rod stiffener can not be installed apart certain distance from each other, depending on a rod size. For example, for ½″ rod a distance between rod stiffeners can not be more than 25″, for ⅝-31″ etc. That means that there might be a need to install a big numbers of rod stiffeners. This is time consuming and expensive

### BRIEF SUMMARY OF THE INVENTION

### Object of the Invention

On the basis of the above-mentioned state of the art, it is the object of the present invention to provide a very simple and easy to install rod stiffener the number of which is always equal 2, no matter what is size and length of a rod.

The objective is achieved, based on the main idea of the invention that is a rod stiffener member (angle, strut channel, pipe, tubing steel etc.) substitutes a rod between the two points of attaching the stiffener to a rod. So, in compression a rod can be considered consisting of three parts: 1. The rod between a structural attachment and a stiffener member; 2. The stiffener member; 3. The rod between the stiffener member and a supported device.

A Rod Stiffener according to the invention comprises, a specially formed washer embracing a rod and a stiffener member and lock nut. The rod stiffeners are attached at the ends of a stiffener member only: one at the top of said stiffener member, another—at the bottom of said stiffener member. So, the number of rod stiffeners to be attached to a rod is always equal 2.

### SUMMARY OF THE INVENTION

A New Rod Stiffener comprises a specially formed washer, a nut and an elongated stiffener member.

The washer has a hole or a cut for the rod and a bended arms, embracing the stiffener member from outside and maintaining the rod inside said stiffener member at a fixed position when tightened in place.

The main idea of the Rod Stiffener is that a rod under compression between two attachments to a stiffener member is substituted by said stiffener member.

### BRIEF DESCRIPTION OF THE SEVERAL VIEWS OF THE DRAWINGS

FIG. 1 shows the main idea of a Rod Stiffener;

FIG. 2 is an isometric views of a Rod Stiffener according to one embodiment of the invention (a stiffener member is an angle);

FIG. 3 is a modifications of a washer plates for the Rod Stiffener, shown on FIG. 2;

FIG. 4 shows how to utilize a rod stiffener on FIG. 3 with a strut channel and a tubing steel;

FIG. 5 is an isometric views of a Rod Stiffener according to another embodiment of the invention (a stiffener member is a strut channel);

FIG. 6 is a modification of a washer plates for the Rod Stiffener, shown on FIG. 5;

FIG. 7 is an isometric views of a Rod Stiffener according to third embodiment of the invention (a stiffener member is a pipe);

FIG. 8 is a modifications of a washer plates for the Rod Stiffener, shown on FIG. 7;

FIG. 9 shows another possible use of the invented Rod Stiffener.

### DETAILED DESCRRIPTION OF THE PREFERRED EMBODIMENTS

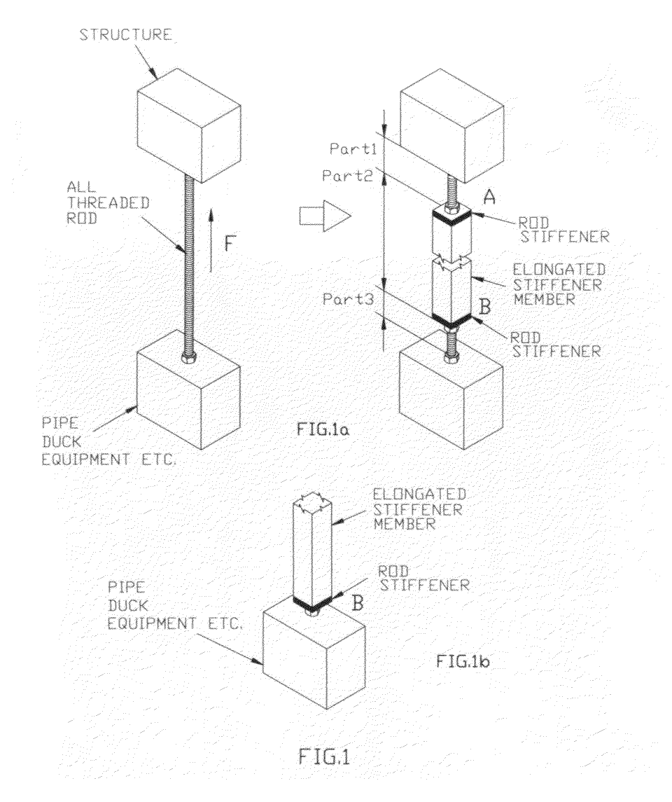

FIG. 1 shows the main idea of a Rod Stiffener.

When a rod is under a compression (force “F”) two rod stiffeners are utilized: one—at the top end of a stiffener member (point “A”), another—at the bottom end of said stiffener member (point “B”). Now the rod can be considered consisting of three parts, arranged in series: a part 1 (a rod), a part 2 (a stiffener member) and a part 3 (a rod). We can place the bottom rod stiffener right on a supported device, as shown on FIG. 1b. Now the rod can be considered consisting of two parts: the part 1, and the part 2. The number of the rod stiffeners is equal to 2 no matter what is a length of the rod between the attaching points “A” and “B”.

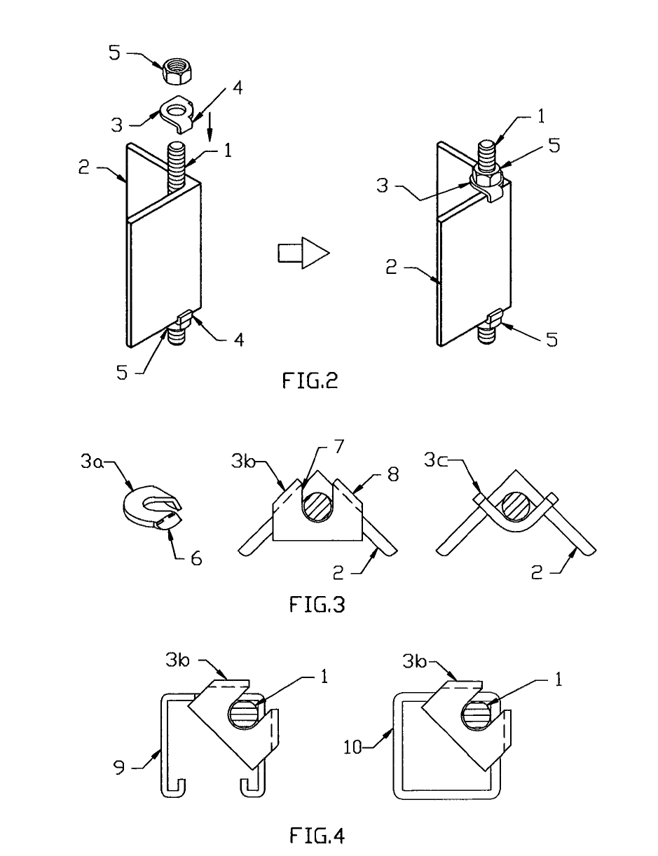

In an embodiment of the invention, shown on FIG. 2 a Rod Stiffener comprises a specially formed washer 3 with bended down arms 4 (or shoulders), a lock nut 5 and an angle 2. The angle 2 is placed on the rod 1, and locked by the nuts 5 the way that the bended arms 4 of the washers 3 embrace the angle 2 from outside, as shown on FIG. 2. So, the rod 1 is inside the stiffener member 2 at a fixed position when the nuts 5 are tightened in place.

FIG. 3 shows different embodiments of a washer plate for the Rod Stiffener, shown on FIG. 2: An item 3a is a round C-Washer with bended down arms 6; an item 3b is a rectangular C-washer with a cut 7 and a bended down arms 8; an item 3c is a round or square bar or plate, with arms, bended down, as shown. All of them can be utilized with already installed hanger rods.

Could be other versions of washers also. For example, a tab lockwashers on each sides of a stiffener member. The crucial thing is that the washer when the nuts are tightened prevents the rod to move in any directions relatively to a stiffener member.

The above described rod stiffener can be utilized with other stiffener members also which has a corner. As an example, on FIG. 4 shown how to utilize a rod stiffener with a strut channel (item 9), and a tubing steel (item 10).

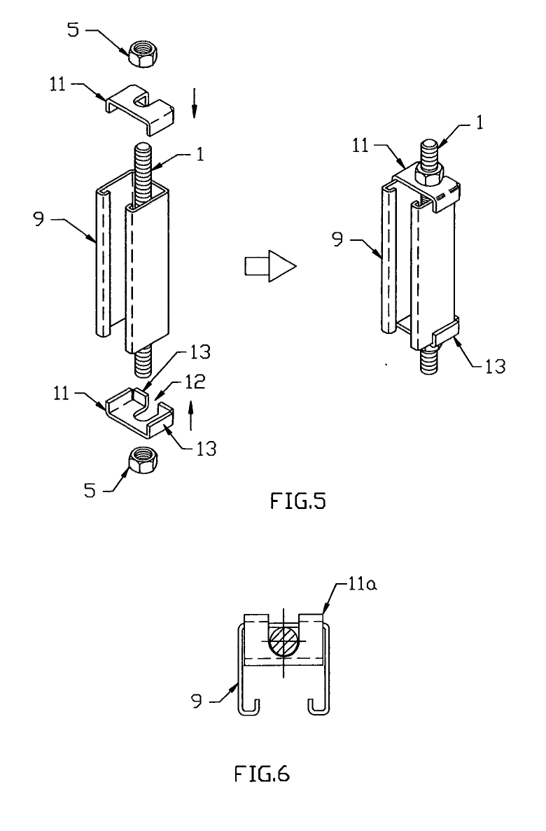

FIG. 5 is an isometric views of a Rod Stiffener according to another embodiment of the invention (a stiffener member is a strut channel—an item 9); The Rod Stiffener comprises a washer 11 and a nut 5. The washer 11 has a cut 12 or a hole for a rod and three bended arms 13 which embrace the strut channel 9 on three sides. The washer can be bended as shown on FIG. 6 also. The crucial thing is that the washer fixes the rod inside the strut channel 9.

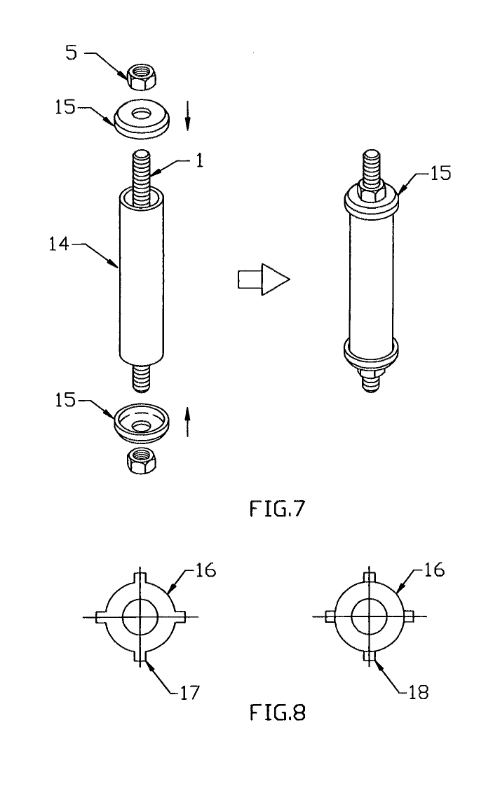

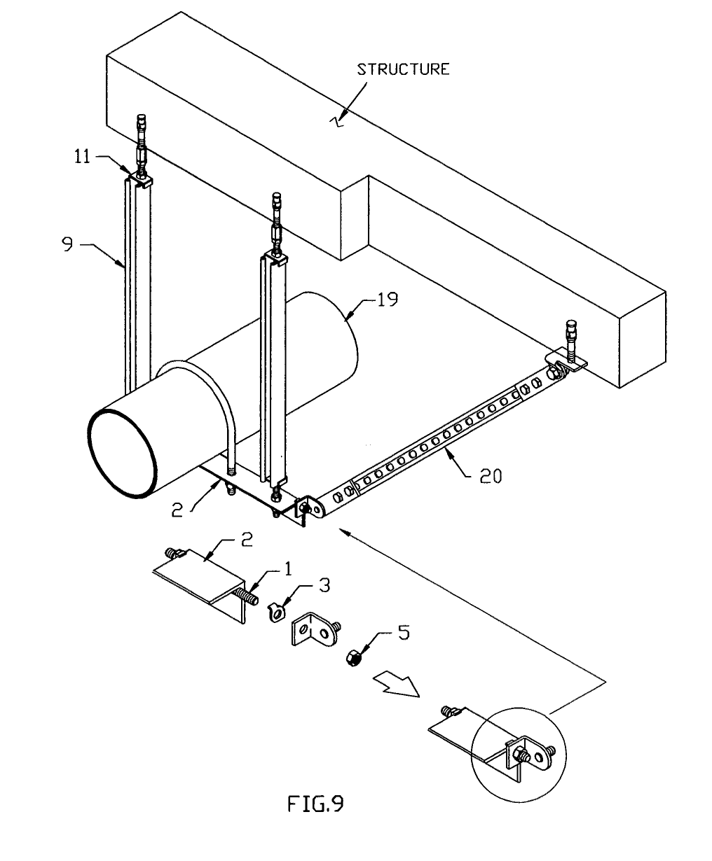

The third embodiment of the invention is shown on FIG. 7 (a stiffener member is a pipe—an item 14). A Rod Stiffener assembly comprises a cup 15 and a nut 5. The cup 15 has a hole for a rod. The Cup 15 can be replaced by a star washer 16, shown on FIG. 8. It has four arms 17 bended down 90 degree. Instead of the arms 17 shoulders 18 can be used also.

The invented Rod Stiffener can be used to attach braces to pipe hangers also. On an example of a trapeze hanger it shown on FIG. 9. Pipe 19 sits on an angle 2 (a strut channel etc.) An all threaded rod 1 is attached to an angle 2 with washers 3 and nuts 5 the way it shown on FIG. 2.

In this example a strut channel 20 is used as a brace. But it could be an angle, a cable etc.

1. A rod stiffener attached only to ends of a stiffener member, so in a compression said stiffener member substitutes said rod between the attachment points.

2. The rod stiffener as recited in claim 1 comprising a formed washer, a nut and an elongated stiffener member, the washer has a hole or a cut for the rod and a bended or formed arms or shoulders, embracing said stiffener member from outside and maintaining said rod inside said stiffener member at a fixed position when bolted in place.

3. The rod stiffener as recited in claim 1 comprising a formed bar or plate, a nut and an elongated stiffener member, the bar has bended arms and embraces the rod placed inside a corner of said stiffener member and two sides of said stiffener member from outside.
